(19) United States
(12) Patent Application Publication
(10) Pub. No.: US 2013/0061889 A1
(43) Pub. Date: Mar. 14, 2013

(54) METHOD FOR CONTROLLING A DOSING SYSTEM WHICH CAN BE POSITIONED INSIDE A WATER-CONDUCTING DOMESTIC APPLIANCE

(71) Applicants: Thorsten Bastigkeit, Wuppertal (DE); Salvatore Fileccia, Oberhausen (DE); Arnd Kessler, Monheim am Rhein (DE); Christian Nitsch, Duesseldorf (DE); Heinz-Dieter Eichholz, Islerlohn (DE); Brigitte Kempen, Koln (DE); Thomas Holderbaum, Hilden (DE); Gerold Jans, Waldburg (DE); Roland Schmalz, Waldburg (DE); Konstantin Benda, Duesseldorf (DE)

(72) Inventors: Thorsten Bastigkeit, Wuppertal (DE); Salvatore Fileccia, Oberhausen (DE); Arnd Kessler, Monheim am Rhein (DE); Christian Nitsch, Duesseldorf (DE); Heinz-Dieter Eichholz, Islerlohn (DE); Brigitte Kempen, Koln (DE); Thomas Holderbaum, Hilden (DE); Gerold Jans, Waldburg (DE); Roland Schmalz, Waldburg (DE); Konstantin Benda, Duesseldorf (DE)

(21) Appl. No.: 13/608,107

(22) Filed: Sep. 10, 2012

Related U.S. Application Data
(63) Continuation of application No. PCT/EP2010/062238, filed on Aug. 23, 2010.

(30) Foreign Application Priority Data
Mar. 11, 2010 (DE) 10 2010 002 750.2

(51) Int. Cl. B08B 3/00

(52) U.S. Cl. 134/57 D; 134/93

(57) ABSTRACT

The invention relates to a method for controlling a dispensing system positionable in the interior of an automatic dishwasher, encompassing a cartridge filled with at least one preparation, a dispenser that is couplable to the cartridge, the dispenser encompassing at least a temperature sensor and a conductivity sensor, such that the temperature sensor and/or the conductivity sensor can be arranged in and/or on and/or outside the dispenser; and a delivery means for releasing a preparation from the cartridge into the interior of the automatic dishwasher.

### CROSS-REFERENCES TO RELATED APPLICATIONS

This application is a continuation of PCT/EP2010/062238, filed on Aug. 23, 2010, which claims priority under 35 U.S.C. §119 to DE 10 2010 002 750.2 filed on Mar. 11, 2010, both of which are hereby incorporated by reference.

### FIELD OF THE INVENTION

The present invention generally relates to a method for controlling a dispensing system positionable in the interior of a water-conveying household appliance, and more particularly relates to an automatic dishwasher.

### BACKGROUND OF THE INVENTION

Dishwashing agents are available to consumers in a large number of presentation forms. In addition to the traditional liquid hand dishwashing agents, automatic dishwashing agents especially have considerable significance now that household automatic dishwashers are widespread. These automatic dishwashing agents are offered to the consumer typically in solid form, for example as powders or tablets, but increasingly also in liquid form. Emphasis has for some time been placed principally on convenient dispensing of washing and cleaning agents, and on simplification of the working steps necessary for carrying out a washing or cleaning method.

Furthermore, one of the main objectives of manufacturers of automatic cleaning agents is to improve the cleaning performance of these agents, increased attention recently having been paid to cleaning performance in low-temperature cleaning cycles resp. in cleaning cycles having reduced water consumption. To this end, new ingredients, for example more-effective surfactants, polymers, enzymes or bleaching agents, have preferably been added to the cleaning agents. Because new ingredients are available only to a limited extent, however, and because for environmental and economic reasons the quantity of the ingredients used for each cleaning cycle cannot be arbitrarily increased, there are natural limits to this approach to a solution.

In this connection, apparatuses for multiple dispensing of washing and cleaning agents have very recently come under scrutiny by product developers. With regard to these apparatuses, a distinction may be made between on the one hand dispensing chambers integrated into the automatic dishwasher or textile washing machine, and on the other hand separate devices independent of the automatic dishwasher or textile washing machine. By means of these apparatuses, which contain several times the quantity of cleaning agent required to carry out a cleaning method, washing- or cleaning-agent portions are automatically or semi-automatically dispensed into the interior of the cleaning machine in the course of multiple successive cleaning processes. For the consumer, the need for manual dispensing for each cleaning resp. washing cycle is eliminated. Examples of such apparatuses are described in European patent application EP 1 759 624 A2 (Reckitt Benckiser) or in German patent application DE 53 5005 062 479 A1 (BSH Bosch and Siemens Hausgeräte GmbH).

A problem with autonomous dispensing apparatuses, i.e. those independent of the control system of an automatic dishwasher, is the sensing and allocation of individual washing program segments, for example the beginning of a washing program, the pre-wash segment, the main washing segment, the rinse-aid segment, and/or the drying segment. Only by means of comparatively accurate detection of the corresponding washing program segments can accurate, demand-compatible dispensing of one or more automatic dishwashing agents from a dispensing apparatus of this kind be realized.

The object of the invention is therefore to make available economical and reliable detection of the beginning of a cleaning program for autonomous dispensing apparatuses of the kind referred to earlier.

This object is achieved by a method according to Claim 1 and by a dispensing system according to Claim 13 for carrying out the method.

The invention will be further explained below using the example of automatic dishwashers. The invention is, however, also readily suitable for other water-conveying household appliances, such as e.g. a washing machine.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method for controlling a dispensing system (1, 2) positionable in the interior of a water-conveying household appliance (38), encompassing a cartridge (1) filled with at least one preparation; a dispenser (2) that is coupled detachably or nondetachably to the cartridge (1), the dispenser (2) encompassing at least a temperature sensor and a conductivity sensor (5), such that the temperature sensor and/or the conductivity sensor (5) can be arranged in and/or on and/or outside the dispenser (2), and a delivery means for releasing a preparation from the cartridge (1) into the interior of the water-conveying household appliance (38), encompassing the steps of measuring (i) at least one first temperature T₁ in the interior of the water-conveying household appliance by means of the temperature sensor, measuring (ii) the resistance R at the conductivity sensor (5), such that steps (a.) and (b.) can occur in any sequence, and when a defined temperature T_{ref} is exceeded, and when the resistance falls below a predefined reference resistance R_{ref} that represents the presence of water at the conductivity sensor (5), a release of at least one volume V1 of a first preparation from the cartridge (1) into the interior of the water-conveying household appliance (38) occurs.

### BRIEF DESCRIPTION OF THE DRAWINGS

The present invention will hereinafter be described in conjunction with the following drawing figures, wherein like numerals denote like elements, and

FIG. 1. Positioning of the dispenser in an automatic dishwasher;

FIG. 2. Positioning of the dispenser in a tableware basket;

FIG. 3. Dispenser having a conductivity sensor arranged on the bottom side;

FIG. 4. Flow chart for the dispensing method for delivering a preparation;

FIG. 5. Flow chart for the dispensing method for time-offset delivery of two preparations; and

FIG. 6. Flow chart for the dispensing method for time-offset delivery of three preparations.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The invention permits economical detection of the beginning of a cleaning program using components that are as economical and technically simple as possible. The result is to ensure, in particular, rapid dispensing at the beginning of a cleaning program in the automatic dishwasher, thereby enabling the longest possible residence time for the respectively dispensed dishwashing preparation in the washing bath. Better cleaning performance is ultimately achieved thanks to the correspondingly optimized exposure times of the dishwashing preparation.

The method according to the present invention for controlling a dispensing system positionable in the interior of an automatic dishwasher encompasses a cartridge filled with at least one preparation; a dispenser that is couplable to the cartridge, the dispenser encompassing at least one temperature sensor and a conductivity sensor, such that the temperature sensor and/or the conductivity sensor can be arranged in and/or on and/or outside the dispenser; and a delivery means for releasing a preparation from the cartridge into the interior of the automatic dishwasher, encompassing the steps of measuring a first temperature T₁ in the interior of the automatic dishwasher by means of the temperature sensor, and measuring the resistance R at the conductivity sensor, such that when the conditions T₁>T_{Ref1}, where T_{Ref1} is a predefined first reference temperature that is equal to at least 30° C., preferably at least 21° C., and R<R_{Ref}, where R_{Ref} is a predefined reference resistance that represents the presence of water at the conductivity sensor, exist, a release of at least one volume V1 of a first preparation from the cartridge into the interior of the automatic dishwasher occurs.

The use of temperature information and conductivity information makes it possible, inter alia, to prevent the dispenser from initiating an undesired dispensing operation in a warm environment, for example during transport, which could occur if temperature data alone were used to control the dispenser.

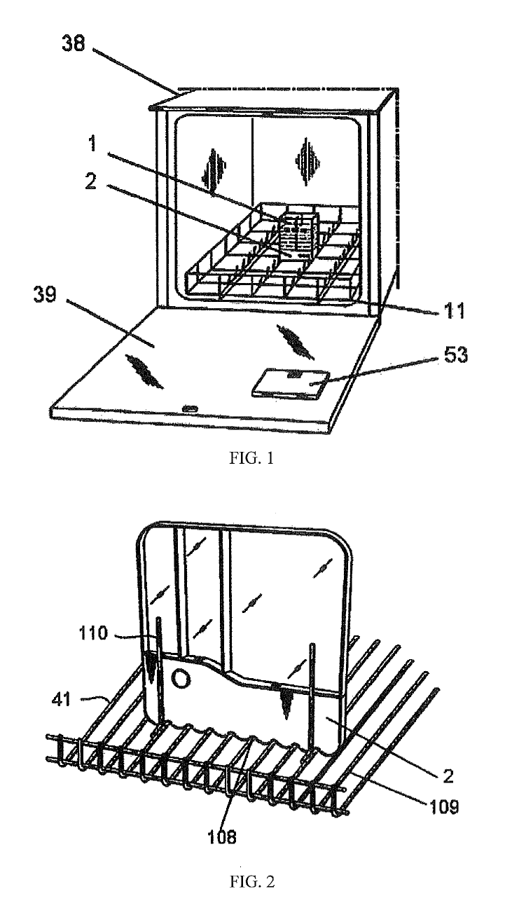

FIG. 1 shows a positionable dispenser 2 having a two-chamber cartridge 1 in tableware rack 11, the automatic dishwasher door 39 of an automatic dishwasher 38 being open. The control unit and the conductivity sensor are arranged in the dispenser. It is evident that dispenser 2 having cartridge 1 is positionable in principle at any point within tableware rack 11, it being advantageous to provide a plate- or cup-shaped dispensing system 1, 2 in a corresponding plate or cup receptacle of tableware rack 11. Located in automatic dishwasher door 39 is a dispensing chamber 53 into which an automatic dishwasher cleaner preparation can be introduced, for example in the form of a tablet. It is advantageous with this embodiment of the invention that when the positionable dispensing system 1, 2 is arranged in the lower or upper (not shown) dishwasher rack 11, preparations 40a, 40b are delivered out of cartridge 1 into the washing bath directly via the outlet openings arranged on the bottom side of the dispenser, so that quick dissolution and uniform distribution of the washing preparations in the washing program is ensured. This furthermore ensures that the conductivity sensor, which is located on the bottom side of the dispenser in the direction of gravity when the dispenser is in the operating position shown, is exposed to direct spraying of the conductivity sensor with water by means of a spray arm when the dishwasher is in operation, and the control unit and conductivity sensor are configured such that a discontinuous, discrete resistance measurement is performed at the conductivity sensor.

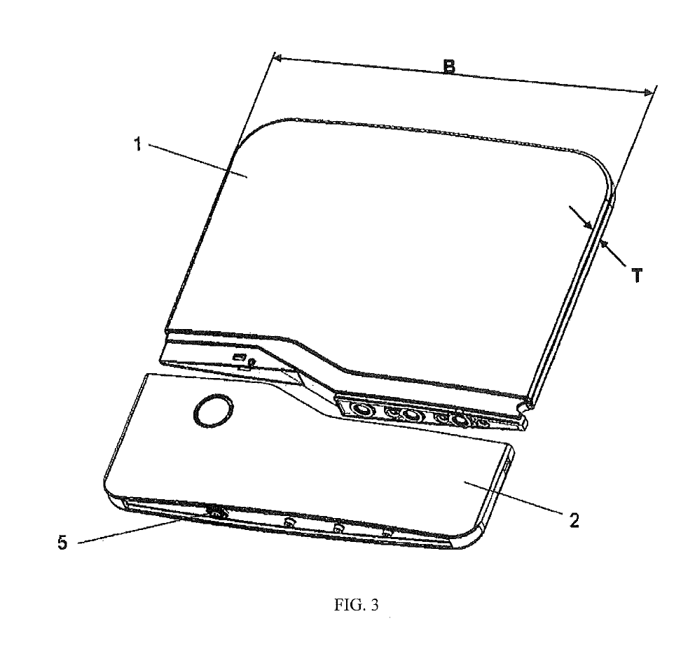

The possible arrangement of the dispenser in the tableware basket of a dishwasher may be gathered from FIG. 2. FIG. 2 shows dispenser 2, coupled to a cartridge 1, in plate receptacle 10 of a tableware rack 41. Tableware rack 41, usually embodied in grid fashion, comprises struts 109 into which fastening means 108 of dispenser 2 engage. This prevents lateral sliding of dispenser 2, for example as tableware rack 41 is pulled out of or pushed into dishwasher 38. This arrangement in the plate receptacle further ensures that the conductivity sensor, which is located on the bottom side of the dispenser in the direction of gravity when the dispenser is in the operating position shown, is exposed to direct spraying of the conductivity sensor with water by means of a spray arm when the dishwasher is in operation.

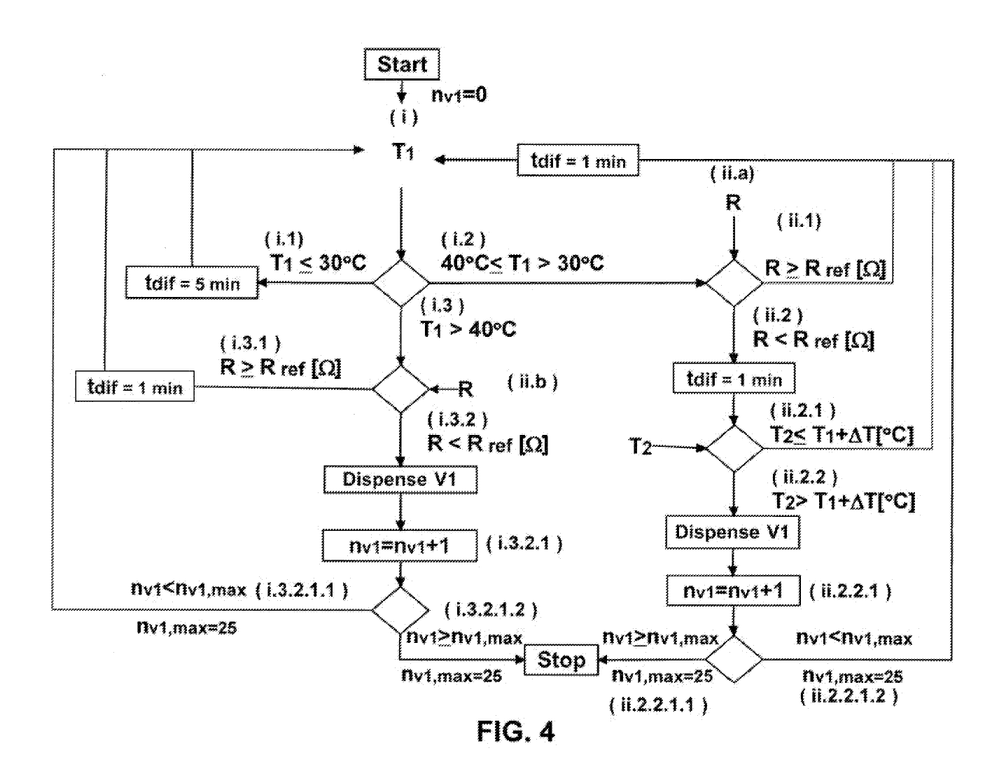

Dispenser 2 comprises on the bottom side a conductivity sensor 5 having an anode and cathode projecting out of the bottom of dispenser 2, as is also clearly apparent in FIG. 3. When dispenser 2 is in the operating position shown in FIG. 1 and FIG. 2, conductivity sensor 5 is arranged on the bottom side of dispenser 2 in the direction of gravity.

The control unit (not visible) arranged in dispenser 2, and conductivity sensor 5, are configured in such a way that a discontinuous, discrete resistance measurement is performed at conductivity sensor 5. The control unit is embodied as an, in particular programmable, microcontroller. The frequency of the resistance measurement is adjusted via the control unit so that it corresponds at least to the maximum rotation frequency of a spray arm in the interior of the automatic dishwasher. In particular, the frequency of the resistance measurement is selected so that at least 100, preferably at least 200 resistance measurements per second are performed at the conductivity sensor.

FIG. 4 shows a flow chart for the method according to the present invention for controlling a dispensing system positionable in the interior of an automatic dishwasher for delivering a preparation into the interior of the automatic dishwasher. The method illustrated makes it possible to detect the beginning of a washing cycle in the interior of an automatic dishwasher with the aid of a dispensing system positionable in the interior of the automatic dishwasher, and to deliver a volume V1 of a first preparation into the interior of the automatic dishwasher.

Starting of the method can be initiated, for example, by means of a manually operable or automatic switch or button. It is conceivable, for example, to initiate starting by means of a switch or button that triggers upon coupling of the cartridge and dispenser.

It is preferable that a first counter nᵥ₁, which represents the number of dispensing operations for the volume V1 of a first preparation, is reset to zero before or at starting of the method.

A temperature rise in the dishwasher is detected by a temperature monitoring function, with the result that the beginning of a washing cycle, which is usually accompanied by an elevation of the temperature in the dishwasher, is sensed. Firstly, therefore, after starting, a measurement (i) of a first temperature T₁ in the interior of the automatic dishwasher is carried out by means of the temperature sensor. If the measured temperature T₁ is less than a first reference temperature (i.1) that is preferably at least 21° C., particularly preferably at least 30° C., another measurement of the temperature T₁ is then initiated after a time interval, the corresponding time interval being between 1 minute and 10 minutes, preferably between 2 and 5 minutes. In order to maintain a low energy consumption for this temperature monitoring function, the temperature is preferably measured not continuously, but instead discretely at predefined intervals of time.

If the measured temperature T₁ exceeds the first reference temperature, the resistance R at the conductivity sensor (ii.a) is then ascertained. If the measured resistance R is greater than a predefined reference resistance R_{ref} (ii.1) that represents the presence of water at the conductivity sensor, another measurement of the temperature T₁ (i) is then initiated after a time interval that is preferably between 30 sec and 10 minutes, particularly preferably between 45 sec and 3 min

If, however, the measured resistance R (ii.a) is less than the predefined reference resistance R_{ref} (ii.2) that represents the presence of water at the conductivity sensor, a second temperature T₂ is then measured by means of the temperature sensor after a time interval T_{diff} that is preferably between 30 sec and 2 min. If a sufficient temperature rise T₁+ΔT (ii.2.1) does not occur between the measurement of the first temperature T₁ and of the temperature T₂, where ΔT lies within the limits of the functional range (0.5 [° C./min]*t_{dif} [min]) to (5 [° C./min]*t_{dif} [min]), another measurement of the temperature T₁ (i) is then initiated after a time interval t_{diff} that is preferably between 30 sec and 10 minutes, particularly preferably between 45 sec and 3 min.

If, however, a sufficient temperature rise T₁+ΔT (ii.2.2) has taken place between the measurement of the first temperature T₁ and of the temperature T₂, a release of the volume V1 of a preparation from the cartridge into the interior of the automatic dishwasher by a corresponding delivery means of the dispenser is then initiated, and a first counter n_{V1} that represents the number of dispensing actions of the volume V1 is incremented by 1 (ii.2.2.1) If the number of dispensing actions is below a defined maximum number n_{V1,max} (ii.2.2.1.2), where n_{V1,max} is preferably between 2 and 50, particularly preferably between 5 and 35, very particularly preferably between 10 and 30, the cartridge then still possesses a fill volume of a first preparation sufficient for a further dispensing action, and another measurement of the temperature T₁ (i) occurs after a time interval t_{diff} that is preferably between 30 sec and 10 minutes, particularly preferably between 45 sec and 3 min.

If the counter n_{V1} has reached the maximum count n_{V1,max} (ii.2.2.1.1), however, the method is then terminated. Starting of the method can be initiated, for example, by insertion of a new, full cartridge, the counter n_{V1} then being reset to zero.

It is also conceivable, however, for the temperature rise of the measured temperature T₁ (i) in the automatic dishwasher after a time interval t_{diff} (i.1) to be so great that a second reference temperature T_{Ref2}, which is greater than the first reference temperature T_{Ref1}, is exceeded (i.3). The second reference temperature T_{Ref2} is preferably between 35° C. and 45° C., particularly preferably between 37° C. and 42° C.

In this case a resistance measurement R (ii.b) is carried out; in the event of a measured resistance R (ii.b) which is lower than the predefined reference resistance R_{ref} (i.3.2.) that represents the presence of water at the conductivity sensor, a release of the volume V1 of a preparation from the cartridge into the interior of the automatic dishwasher by a corresponding delivery means of the dispenser is then initiated, and the first counter n_{V1}, which represents the number of dispensing actions of the volume V1, is incremented by 1 (i.3.2.1). If the number of dispensing actions is below the defined maximum number n_{V1,max} (i.3.2.1.1), the cartridge then still possesses a fill volume of a first preparation sufficient for a further dispensing action, and another measurement of the temperature T₁ occurs (i).

If the counter n_{V1} has reached the maximum count n_{V1,max} (i.3.2.1.2), however, the method is then terminated. Starting of the method can be initiated, for example, by inserting a new, full cartridge, the counter n_{V1} then being reset to zero.

It is preferred that a polarity reversal of the electrodes of the conductivity sensor occur at each conductivity measurement in order to preclude, as a possible source of measurement error, electrode partitioning caused by ion clouds in DC voltage mode.

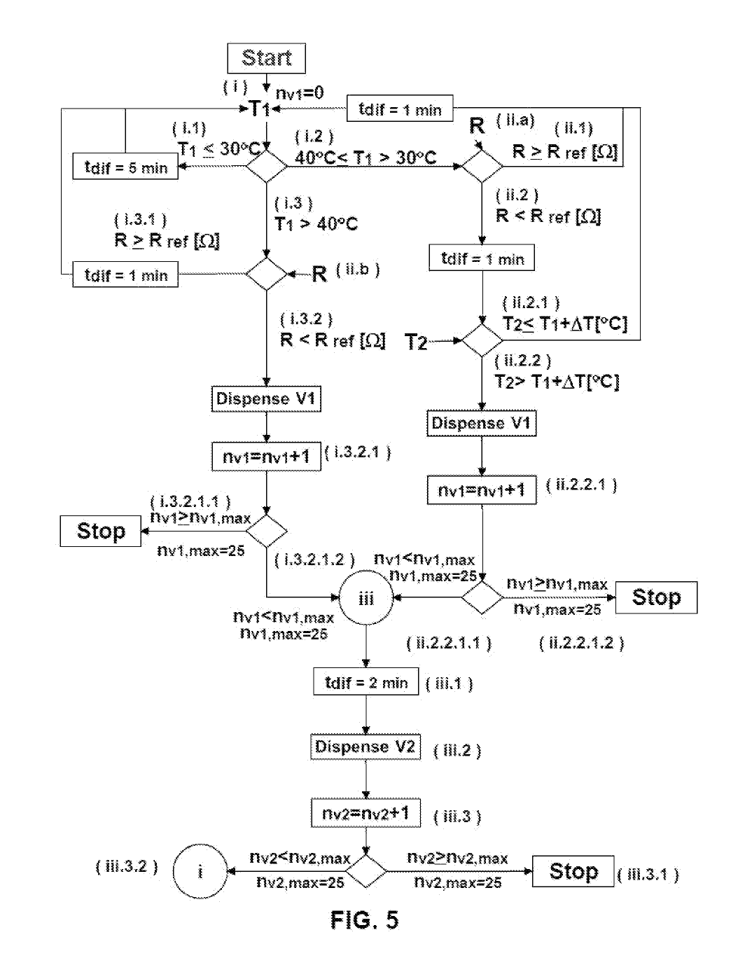

FIG. 5 is a flow chart for a dispensing method for time-offset delivery of two preparations that differ from one another. As is evident from FIG. 5, the method sequence initially corresponds substantially to the method sequence, known from FIG. 4, for dispensing one preparation.

After method steps (1.3.2.1.1) and/or (ii.2.2.1.2), however, another measurement of the temperature T₁ (i) does not occur as shown in FIG. 4, but instead what follows is the method segment (iii) which is explained in further detail below.

After dispensing of the first volume V1 of the first preparation, dispensing of a second volume (iii.2) of a second preparation that is different from the first preparation occurs after a time interval t_{diff} (iii.1) that is preferably between 30 sec and 10 min, particularly preferably between 45 sec and 5 min, very particularly preferably between 1 min and 3 min. Preferably the first preparation is an enzyme-containing preparation and the second preparation is an alkaline preparation. It is further preferred that the dispensing volume V2 be equal to approximately 1*V1 to 10*V1, particularly preferably 2*V1 to 7*V1, very particularly preferably 3*V1 to 5*V1.

It is advantageous that for the dispensing of V2, sub-quantities V2 of V2 are dispensed repeatedly in order to arrive at the target volume V2; it is particularly preferred that the dispensed sub-quantities be identical, and be equal to V1 or to a multiple of V1.

In a further, preferred embodiment of the invention, a time interval without product delivery exists between the dispensing of the sub-quantities, the time interval being selected so that floating of the float in the predispensing chamber is ensured.

Optionally, after the dispensing of the volume V2 (iii.2) a second counter n_{V2} that represents the number of dispensing actions of the volume V2 is incremented by 1 (iii.3). If the number of dispensing actions is below a defined maximum number n_{V2,max} (iii.3.2), n_{V2,max} preferably being between 2 and 50, particularly preferably between 5 and 35, very particularly preferably between 10 and 30, and corresponding in particularly advantageous fashion to the defined maximum number n_{V1,max} of dispensing actions of V1, the cartridge then still possesses a fill volume of a first preparation sufficient for a further dispensing action, and another measurement of the temperature T₁ occurs (i).

If the counter n_{V2} has reached the maximum count n_{V2,max} (iii.3.1), however, the method is then terminated. Starting of the method can then be initiated, for example, by insertion of a new, full cartridge, the counter n_{V2}—and preferably the counter n_{V1} as well—then being reset to zero.

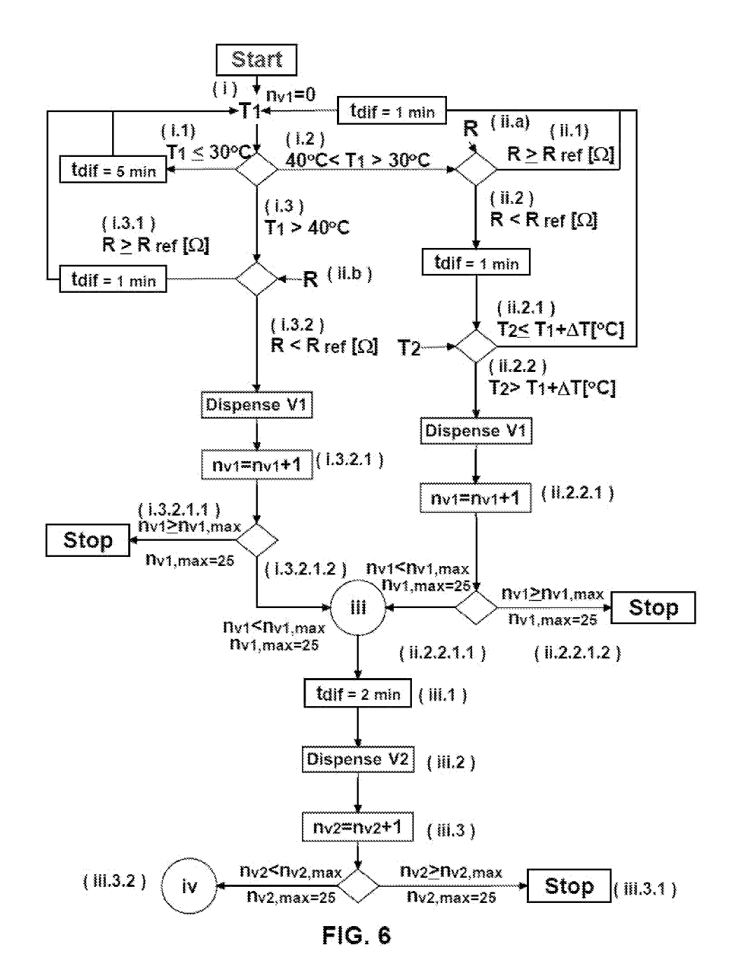

A flow chart for a dispensing method for time-offset delivery of three preparations that differ from one another is reproduced in FIG. 6. As may easily be gathered from FIG. 6, the method sequence initially corresponds to the method sequence, known from FIG. 5, for time-offset dispensing of two preparations. Deviating from the method sequence shown in FIG. 5, however, in FIG. 6 another measurement of the temperature T₁ (i) is not initiated at the method step (iii.3.2), but instead the method step (iv) is performed, for example by dispensing a rinse aid preparation after a predefined time.

Measurement of the temperature T₁ and of the resistance R at the conductivity sensor can occur successively or simultaneously. It is preferred that firstly the temperature T₁ and then the resistance R be measured. It is also conceivable, however, to measure first the resistance R and then the temperature T₁.

When the conditions recited above exist it is also possible to dispense more than one volume V1 of a preparation from the cartridge into the interior of the automatic dishwasher. For example, a first volume V1 of a first preparation and a second volume V2 of a second preparation can also be dispensed substantially simultaneously; it is particularly preferred that the preparations be different from one another.

It is particularly preferred to configure the method in such a way that when the condition T₁>T_{Ref1} and R<R_{Ref} exists, a temperature measurement of a second temperature T₂ occurs by means of the temperature sensor after a predefined time interval t_{dif}, in particular after 10 to 600 sec, preferably after 30 to 240 sec, particularly preferably 45 to 100 sec; and when the condition T₂>T₁+ΔT exists, where ΔT lies within the limits of the functional range (0.5 [° C./min]*t_{dif} [min]) to (5 [° C./min]*t_{dif} [min]), a release of at least one volume V1 of a first preparation from the cartridge into the interior of the automatic dishwasher occurs. This detects in particular a temperature rise that occurs in the heating-up phase of the dishwasher, in particular in the main washing segment of a washing program.

In a further, advantageous embodiment of the method, when the condition T₁≦T_{Ref1} exists, another temperature measurement of the first temperature T₁ is initiated after a predefined time t_{dif}, in particular after 2 to 10 minutes, preferably after 3 to 7 minutes, particularly preferably 4 to 6 minutes. In order to maintain a low energy consumption for the temperature monitoring function, the temperature is preferably measured not continuously, but instead at predefined time intervals.

It is also conceivable, however, for the temperature rise of the measured temperature T₁ in the automatic dishwasher to be so great, in particular at the beginning of a cleaning program, that a second reference temperature T_{ref2} which is greater than the first reference temperature T_{Ref1} is exceeded. For this case of a rapid and significant temperature rise, it is furthermore advantageous that when the condition T₁>T_{Ref2} exists, where T_{Ref2} is a second reference temperature that is equal to at least 35° C., preferably at least 40° C., a measurement of the resistance R at the conductivity sensor occurs, and when the condition R<R_{Ref} exists, where R_{Ref} is a predefined reference resistance that represents the presence of water at the conductivity sensor, an immediate release of at least one volume V1 of a first preparation from the cartridge into the interior of the automatic dishwasher occurs.

In an advantageous refinement of the method according to the present invention, when the condition R≧R_{Ref} exists, where R_{Ref} is a predefined reference resistance that represents the presence of water at the conductivity sensor, another temperature measurement of the first temperature T₁ occurs after a predefined time t_{ref}, in particular after 10 to 600 sec, preferably after 30 to 240 sec, particularly preferably 45 to 100 sec. This time interval is preferably less than or equal to the time interval that exists before measurement of the first temperature T₁ when the condition T₁≦T_{Ref1} exists. If a temperature above the first reference temperature T_{Ref1} is measured in the interior of the dishwasher, but no water is measured at the conductivity sensor, the dispenser is then therefore switched, by means of shortened monitoring intervals for measurement of the first temperature T₁, into an intensified monitoring mode so that quasi-synchronous detection of water in the dishwasher is made possible by the shortened monitoring intervals.

It can also be advantageous to provide the dispensing of two preparations that differ from one another in time-offset fashion. This is the case especially when dispensing two preparations that are not shelf-stable with one another. Provision is thus made, in a refinement of the method according to the present invention, that after dispensing of the first volume V1, dispensing of a second volume V2 of a second preparation from the cartridge into the interior of the automatic dishwasher occurs, the first preparation being different from the second preparation and a predefined time interval t_{diff}, preferably between 30 and 300 sec, particularly preferably between 60 and 240 sec, very particularly preferably between 60 and 150 sec, being present between the dispensing of V1 and of V2.

It is particularly preferred that the first preparation be an enzyme-containing preparation and the second preparation an alkaline preparation.

It is furthermore advantageous that the dispensed volume V2 be equal to approximately 1*V1 to 10*V1, particularly preferably 2*V1 to 7*V1, very particularly preferably 3*V1 to 5*V1.

It is of course also conceivable to refine the method according to the present invention in such a way that after the dispensing of the first volume V1 and of the second volume V2, dispensing of a third volume V3 of a third preparation from the cartridge into the interior of the water-conveying household appliance occurs, the third preparation being different from the first and the second preparation.

It is particularly preferred in this context that the third preparation be a rinse aid preparation.

The individual elements of the method and system according to the present invention will be further explained below.

### Dispenser

Integrated into the dispenser are, in particular, the control unit necessary for execution of the method according to the present invention, as well as at least one sensor unit, in particular a conductivity sensor. An actuator and/or an energy source are preferably likewise arranged on or in the dispenser.

It is particularly preferred that the dispenser encompass at least one first interface that interacts with a corresponding interface embodied in or on an automatic dishwasher, in such a way that a transfer of electrical energy and/or signals from the dishwasher to the dispenser and/or from the dispenser to the dishwasher is effected.

In an embodiment of the invention, the interfaces are embodied by plug connectors. In a further embodiment, the interfaces can be embodied in such a way that a wireless transfer of electrical energy and/or of electrical and/or optical signals is brought about.

It is particularly preferred in this context that the interfaces provided for the transfer of electrical energy be inductive transmitters resp. receivers of electromagnetic waves. In particular, for example, the interface of an automatic dishwasher can be embodied as a transmitter coil operated with alternating current and having an iron core, and the interface of the dispenser as a receiver coil having an iron core.

In an alternative embodiment, the transfer of electrical energy can also be provided by means of an interface that comprises on the dishwasher side an electrically operated light source and on the dispenser side a light sensor, for example a photodiode or a solar cell. The light emitted by the light source is converted by the light sensor into electrical energy, which then in turn feeds into, for example, a dispenser-side storage battery.

In an advantageous refinement of the invention, an interface is provided on the dispenser and on the dishwasher for transferring (i.e. transmitting and receiving) electromagnetic and/or optical signals that in particular represent operating-state, measurement and/or control-information items of the dispenser and/or of the dishwasher.

It is of course possible to provide only an interface for the transfer of signals or an interface for the transfer of electrical energy, or one interface for the transfer of signals and one interface for the transfer of electrical energy, respectively, or to provide an interface that is suitable for providing a transfer of both electrical energy and signals.

An interface of this kind can be embodied in particular in such a way that a wireless transfer of electrical energy and/or electromagnetic and/or optical signals is produced.

It is particularly preferred that the interface be configured for the emission and/or reception of optical signals. It is very particularly preferred that the interface be configured for the emission resp. reception of light in the visible region. Because darkness usually exists in the interior of the washing space during operation of an automatic dishwasher, signals in the visible optical region can be emitted and detected by the dispenser, for example in the form of signal pulses resp. light flashes. It has emerged as particularly advantageous to use wavelengths between 600 and 800 nm in the visible spectrum.

Alternatively or additionally, it is advantageous that the interface is configured for the emission resp. reception of infrared signals. It is advantageous in particular that the interface is configured for the emission resp. reception of infrared signals in the near infrared range (780 nm to 3000 nm).

The interface encompasses in particular at least one LED. Particularly preferably, the interface encompasses at least two LEDs. It is also possible, according to a further preferable embodiment of the invention, to provide at least two LEDs that emit light at wavelengths that differ from one another. This makes it possible, for example, to define different signal bands on which information can be sent resp. received.

It is further advantageous, in a refinement of the invention, for at least one LED to be an RGB LED whose wavelength is adjustable. It is thus possible, for example, to define with one LED a variety of signal bands that emit signals at different wavelengths. It is thus also conceivable, for example, for light to be emitted during the drying operation, during which high humidity (mist) exists in the washing space, at a different wavelength than, for example, during a washing step.

The interface of the dispenser can be configured so that the LED is provided both for the emission of signals into the interior of the dishwasher, in particular when the automatic dishwasher door is closed, and also for optical indication of an operating state of the dispenser, in particular when the automatic dishwasher door is open.

It is particularly preferred that an optical signal be embodied as a signal pulse having a pulse duration of between 1 ms and 10 second, preferably between 5 ms and 100 ms.

It is further advantageous that the interface of the dispenser is configured in such a way that it emits, when the automatic dishwasher is closed and unloaded, an optical signal that produces an average illumination intensity E of between 0.01 and 100 lux, preferably between 0.1 and 50 lux, measured at the walls delimiting the washing space. This illumination intensity is then sufficient to produce multiple reflections with resp. at the other washing-space walls, and thereby to reduce or prevent signal shadows in the washing resp. drying space, especially when the automatic dishwasher is in the loaded state.

The signal emitted and/or received by the interface is in particular a carrier of information, in particular a control signal or a signal that represents an operating state of the dispenser and/or of the dishwasher.

The optical transmitting unit can be in particular an LED that preferably radiates light in the visible and/or IR region. It is also conceivable to use another suitable optical transmitting unit, such as for example a laser diode. It is particularly preferable to use optical transmitting units that emit light in the wavelength range between 600 and 800 nm.

In an advantageous refinement of the invention, the dispenser can encompass at least one optical receiving unit. This makes it possible, for example, for the dispenser to receive signals from an optical transmitting unit arranged in the household appliance. This can be implemented by way of any suitable optical receiving unit, for example photocells, photomultipliers, semiconductor detectors, photodiodes, photoresistors, solar cells, phototransistors, CCD and/or CMOS image sensors. It is particularly preferred that the optical receiving unit be suitable for receiving light in the wavelength region from 600 to 800 nm.

The signals emitted by the transmitting unit into the environment of the dispenser can preferably represent information with regard to operating states or control instructions.

### Sensors

The dispensing unit preferably comprises at least one sensor that is suitable for sensing a temperature. The temperature sensor is embodied in particular for sensing a water temperature.

It is preferred that the dispensing unit encompass a sensor for sensing conductivity, with which, in particular, the presence of water resp. the spraying of water, in particular in an automatic dishwasher, is sensed.

In an advantageous embodiment of the invention, the sensor unit encompasses at least one, at least two-pole, conductivity sensor. At least two poles of the conductivity sensor preferably have a spacing of 2 to 25 mm, preferably 5 to 15 mm, in particular preferably approx. 12 mm.

It has proven to be particularly advantageous that at least two poles of a conductivity sensor are encased with an electrically conductive silicone; it is particularly preferable that a substantially planar surface be configured between the silicone and the dispenser bottom. As a result of the elastomeric properties of the conductive silicone, the sensor can be simply and effectively sealed with respect to the environment, and recessed into a housing wall of the dispenser.

In order to maintain measurement accuracy even over a large number of measurements, it is advantageous that a polarity reversal at the two-pole conductivity sensor occurs after each resistance measurement, so that excess charges cannot form on the conductivity sensor.

It is particularly preferred that at least two sensor units be provided for measuring parameters that differ from one another, very particularly preferably one sensor unit being a conductivity sensor and a further sensor unit being a temperature sensor.

The sensors are in particular adjusted for detecting the beginning, progress, and end of a washing program. By way of non-exhaustive example, the sensor combinations listed in the table below can be used for this purpose:

| Sensor 1 | Sensor 2 | Sensor 3 | Sensor 4 |
|---|---|---|---|
| Conductivity sensor | Temperature sensor | | |
| Conductivity sensor | Temperature sensor | Brightness sensor | |
| Conductivity sensor | Temperature sensor | Brightness sensor | Turbidity |
| | | | sensor |

By means of the conductivity sensor it is possible to detect, for example, whether the conductivity sensor is wetted by water, so that it can thereby e.g. be ascertained whether water is present in the automatic dishwasher.

The conductance or conductivity sensor can be made up of an electrically conductive anode and cathode, which project out of the housing of the dispenser into the interior of the automatic dishwasher or are connected in electrically conductive fashion to the interior of the automatic dishwasher. The spacing of the anode and cathode is preferably selected so that during operation of the dishwasher, an electrically conductive water bridge can form between the anode and cathode; this can be measured by a drop in the resistance between the anode and cathode.

Washing programs as a rule exhibit a characteristic temperature profile, which is determined inter alia by the heating of the washing water and drying of the items being washed, and which can be sensed using a temperature sensor.

A brightness sensor can be used, for example, to detect the incidence of light into the interior of a dishwasher when the automatic dishwasher door is opened, from which it may for example be inferred that the washing program has ended.

A turbidity sensor can also be provided in order to determine the degree of soiling of the items to be washed in the cleaning machine. This also allows, for example, selection in the dispenser of a dispensing program appropriate for the soiling situation that has been identified.

To allow efficient production and assembly of the dispenser, it is also possible for at least one sensor unit to be arranged on or in the control unit. For example, it is possible to provide a temperature sensor in the dispenser resp. directly on the circuit board carrying the control unit, so that the temperature sensor has no direct contact with the environment.

In a particularly preferred embodiment of the invention, the sensor is arranged at the bottom of the dispenser, the bottom of the dispenser being directed, in the utilization position, downward in the direction of gravity. It is particularly preferred in this context that the sensor unit encompass a temperature sensor and/or a conductivity sensor. A configuration of this kind ensures that water is conveyed by the spray arms of the dishwasher onto the underside of the dispenser and thus brought into contact with the sensor. Because the distance between the spray arms and the sensor is as short as possible as a result of the bottom-side arrangement of the sensor, the water experiences only slight cooling between emergence at the spray arms and contact with the sensor, so that a maximally accurate temperature measurement can be carried out.

To decrease the dispenser's energy consumption resp. extend the service life of the energy source, in particular of a battery, the energy consumption points of the dispenser, in particular the control unit, can be connected to the energy source with inclusion of an on-off switch, and the energy source can be put under load only after the “on” state of the on-off switch is reached, such that a sensor unit constitutes the on-off switch, or is connected thereto and switches the latter.

It is particularly preferred that the sensor unit downward on the bottom of the dispenser comprise two contacts in contact with the environment, these in particular being embodied as contact pins projecting downward out of the bottom; that one contact be connected as an anode contact and the other contact as a cathode contact relative to the energy source; and that the on-off switch that is in the “off” state remain in the “off” state with no electrically conductive connection between the contacts, and that the on-off switch that is in the “off” state be switched into the “on” state upon occurrence of an electrically conductive connection between the contacts.

It is further preferred that the on-off switch be provided resp. combined with a self-hold circuit that ensures resp. brings about self-holding of the energy supply of the energy consumption points once the “on” state of the on-off switch is reached, until the control unit outputs a switch-off signal.

The on/off switch can be embodied in particular as a transistor circuit. It is preferable in this context that the transistor of the on/off switch be embodied as a pnp transistor and connected at the emitter, optionally via a control application circuit, to the supply voltage; at the collector, optionally via a control application circuit, to ground and to the cathode contact; and at the base on the one hand, optionally via a control application circuit, to the supply voltage, and on the other hand, optionally via a control application circuit, to the anode contact.

The control application circuit preferably comprises at least one control resistor that is embodied in particular as a resistor-type voltage divider.

It is very particularly advantageous that besides the on/off sensor unit, a sensor unit embodied as a conductivity sensor is provided, which comprises, downward on the bottom of the dispenser, two contacts in contact with the environment; and that the anode contact of the on/off sensor unit is simultaneously the anode contact of the sensor unit that constitutes the conductivity sensor. It thereby becomes possible to implement an on/off switch and a conductivity sensor in one component (a transistor).

It is also possible for the sensor unit constituting the temperature sensor to be integrated into a contact, in particular the cathode contact, of the sensor unit constituting the conductivity sensor.

That contact of the sensor unit constituting the conductivity sensor which receives the temperature sensor can preferably be embodied as a hollow contact pin in which the temperature sensor of the sensor unit constituting the temperature sensor is arranged.

It is particularly preferred that the contacts of a conductivity sensor arranged on the bottom side be surrounded by an electrically conductive silicone. The conductivity sensor can be embodied in this context in particular in the form of a resistance measurement between two contacts that are spaced apart from one another and are in contact with the environment of the dispenser. It is very particularly preferable in this context that the silicone be embedded flush into the bottom of the dispenser. Advantageously, the silicone has an approximately circular base surface. Silicone exhibits good wettability with water, and thus furnishes good measurement results in terms of the detection of water in the dishwasher.

In order to avoid polarization, which would negatively affect sensor accuracy, at the contacts of the conductivity sensor when a DC voltage source is used, it is advantageous to perform two successive resistance measurements at the conductivity sensor using a different polarity in each case, i.e. with the positive and negative poles resp. anode and cathode contacts transposed, so that excess charges cannot form at the contacts.

### Control Unit

A “control unit” for purposes of this Application is an apparatus that is suitable for influencing the transportation of material, energy, and/or information. For this purpose, the control unit influences actuators with the aid of information, in particular measurement signals of the sensor unit, which it processes for purposes of the control objective.

The control unit can be in particular a programmable microprocessor. In a particularly preferred embodiment of the invention a plurality of dispensing programs are stored on the microprocessor.

In a preferred embodiment, the control unit has no connection to the household appliance controller that is possible present. No data, in particular electrical, optical, or electromagnetic signals, are therefore exchanged directly between the control unit and the household appliance controller.

In an alternative embodiment of the invention, the control unit is coupled to the household appliance controller that is present. This coupling is preferably embodied wirelessly. It is possible, for example, to position a transmitter on or in an automatic dishwasher, by preference on or at the dispensing chamber recessed into the door of the automatic dishwasher, which transmitter wirelessly transfers a signal to the dispensing unit when the household appliance controller brings about dispensing, for example, of a cleaning agent out of the dispensing chamber, or of rinse aid.

Multiple programs for the release of different preparations, or for the release of automatic dishwashing preparations, can be stored in the control unit.

For the dispensing in particular of preparations that tend to gel, the control unit can be configured in such a way that on the one hand dispensing occurs in a sufficiently short time to ensure a good cleaning result, and on the other hand the preparation is not dispensed so quickly that gelling of the surge of preparation occurs. This can be achieved, for example, by way of an interval-type release, the individual dispensing intervals being adjusted so that they trigger the entirety of the correspondingly dispensed quantity during one cleaning cycle.

It is particularly preferred that the dispensing intervals for delivery of a preparation be between 30 and 90 seconds, particularly preferably 45 to 75 seconds.

The delivery of preparations out of the dispenser can occur sequentially or simultaneously.

It is particularly preferred to dispense a plurality of preparations sequentially in one washing program. The following dispensing sequences, in particular, are to be preferred:

| Dis- | Dis- | Dis- | Dis- |
|---|---|---|---|
| pensing | pensing | pensing | pensing |
| action 1 | action 2 | action 3 | action 4 |
| Enzymatic cleaning | Alkaline cleaning | | |
| preparation | preparation | | |
| Alkaline cleaning | Rinse aid | | |
| preparation | | | |
| Enzymatic cleaning | Alkaline cleaning | Rinse aid | |
| preparation | preparation | | |
| Enzymatic cleaning | Alkaline cleaning | Rinse aid | Dis- |
| preparation | preparation | | infectant |
| | | | prepara- |
| | | | tion |
| Enzymatic cleaning | Alkaline cleaning | Rinse aid | Scent |
| preparation | preparation | | |
| Pretreatment | Enzymatic cleaning | Alkaline-cleaning | Rinse aid |
| preparation | preparation | preparation | |

It is furthermore advantageous that at least one enzyme-containing preparation and/or alkaline preparation is released in the pre-washing and/or main washing program of the automatic dishwasher, the release of the enzyme-containing preparation preferably occurring earlier in time than the release of the alkaline preparation. It is further preferred that the dispensing of the rinse aid occur in the rinse-aid program of the automatic dishwasher.

In an advantageous refinement of the invention, data such as, for example, control and/or dispensing programs of the control unit or operating parameters or protocols stored by the control unit can be read out of the control unit or loaded into the control unit. This can be implemented, for example, by means of an optical interface, the optical interface being connected correspondingly to the control unit. The data to be transferred are then encoded and emitted resp. received as light signals, in particular in the visible region, the wavelength range between 600 and 800 nm being preferred. It is also possible, however, to use a sensor present in the dispenser for transferring data out of and/or to the control unit. For example, the contacts of a conductivity sensor, which are connected to the control unit and make available a conductivity determination by means of a resistance measurement at the contacts of the conductivity sensor, can be used for data transfer.

### Cartridge

For purposes of this Application, a “cartridge” is understood as a packaging means that is suitable for encasing or holding together at least one flowable, pourable or scatterable preparation, and is couplable to a dispenser in order to deliver at least one preparation.

In the simplest conceivable embodiment, the cartridge comprises a (preferably dimensionally stable) chamber for stocking a preparation. In particular, a cartridge can also encompass multiple chambers that are fillable with compositions that differ from one another.

The cartridge is embodied in particular for the reception of flowable washing or cleaning agents. Particularly preferably, a cartridge of this kind comprises a plurality of chambers for spatially separated reception of preparations of a washing or cleaning agent that each differ from one another. By way of example, but not exhaustively, some possible combinations for filling the chambers with different preparations are listed below:

| | Chamber 1 | Chamber 2 | Chamber 3 | Chamber 4 |
|---|---|---|---|---|
| A | Alkaline | Enzymatic | — | — |
| | cleaning | cleaning | | |
| | preparation | preparation | | |
| B | Alkaline | Enzymatic | Rinse aid | — |
| | cleaning | cleaning | | |
| | preparation | preparation | | |
| C | Alkaline | Enzymatic | Rinse aid | Scent |
| | cleaning | cleaning | | |
| | preparation | preparation | | |
| D | Alkaline | Enzymatic | Rinse aid | Disinfectant |
| | cleaning | cleaning | | preparation |
| | preparation | preparation | | |
| E | Alkaline | Enzymatic | Rinse aid | Pretreatment |
| | cleaning | cleaning | | preparation |
| | preparation | preparation | | |

It is particularly preferred that all preparations be flowable, since this ensures, for example, rapid dissolution of the preparations in the washing bath of the dishwasher, with the result that these preparations achieve a rapid to immediate cleaning resp. rinsing effect, in particular including on the walls of the washing space and/or of a light guide of the cartridge and/or of the dispenser.

As mentioned above, the cartridge preferably possesses three chambers. For use of a cartridge of this kind in an automatic dishwasher, it is particularly preferred that one chamber contain an alkaline cleaning preparation, a further chamber an enzymatic preparation, and a third chamber a rinse aid, the volume ratio of the chambers being equal to approximately 4:1:1.

The chamber containing the alkaline cleaning preparation preferably has the largest internal volume of the chambers that are present. The chambers that stock an enzymatic preparation resp. a rinse aid preferably have approximately the same internal volumes.

The cartridge encompasses a cartridge bottom which, in the service position, is directed downward in the direction of gravity, and on which at least one outlet opening arranged on the bottom side in the direction of gravity is preferably provided for each chamber. The outlet openings arranged on the bottom side are, in particular, embodied in such a way that at least one outlet opening, preferably all outlet openings, are communicatively connectable to the inlet openings of the dispensing unit, i.e. preparation can flow through the outlet openings out of the cartridge into the dispenser, preferably under the influence of gravity.

It is also conceivable for one or more chambers to have an outlet opening not arranged on the bottom side in the direction of gravity. This is advantageous in particular when, for example, a scent is to be delivered into the environment of the cartridge.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for controlling a dispensing system positionable in the interior of a water-conveying household appliance, encompassing
a cartridge filled with at least one preparation,
a dispenser that is coupled detachably or nondetachably to the cartridge, the dispenser encompassing at least,
a temperature sensor and a conductivity sensor, such that the temperature sensor and/or the conductivity sensor can be arranged in and/or on and/or outside the dispenser, and
a delivery means for releasing a preparation from the cartridge into the interior of the water-conveying household appliance,
encompassing the steps of
a. measuring (i) at least one first temperature T₁ in the interior of the water-conveying household appliance by means of the temperature sensor,
b. measuring (ii) the resistance R at the conductivity sensor,
such that steps (a.) and (b.) can occur in any sequence,
and when a defined temperature T_{ref} is exceeded, and when the resistance falls below a predefined reference resistance R_{ref} that represents the presence of water at the conductivity sensor, a release of at least one volume V1 of a first preparation from the cartridge into the interior of the water-conveying household appliance occurs.

2. The method according to claim 1, wherein when the conditions
T₁>T_{Ref1}, where T_{Ref1} is a predefined first reference temperature that is equal to at least 21° C., preferably at least 30° C., and
R<R_{Ref}, where R_{Ref} is a predefined reference resistance that represents the presence of water at the conductivity sensor,
exist,
a release of at least one volume V1 of a first preparation from the cartridge into the interior of the water-conveying household appliance occurs.

3. The method according to claim 1, wherein
when the condition T₁>T_{Ref1} and R<R_{Ref} exists, a temperature measurement of a second temperature T₂ occurs by means of the temperature sensor after a predefined time interval t_{dif} of 10 to 600 sec, and
when the condition T₂>T₁+ΔT exists, where AT lies within the limits of the functional range (0.5 [° C./min]*t_{dif} [min]) to (5 [° C./min]*t_{dif} [min]), a release of at least one volume V1 of a first preparation from the cartridge into the interior of the water-conveying household appliance occurs.

4. The method according to claim 1, wherein when the condition T₁>T_{Ref2} exists, where T_{Ref2} is a second reference temperature that is equal to at least 35° C., preferably at least 40° C., a measurement of the resistance R at the conductivity sensor occurs, and when the condition R<R_{Ref} exists, where R_{Ref} is a predefined reference resistance that represents the presence of water at the conductivity sensor, a release of at least one volume V1 of a first preparation from the cartridge into the interior of the water-conveying household appliance occurs.

5. The method according to claim 1, wherein after dispensing of the first volume V1, dispensing of a second volume V2 of a second preparation from the cartridge into the interior of the water-conveying household appliance occurs, the first preparation being different from the second preparation and a predefined time interval t_{diff} of between 30 and 300 sec being present between the dispensing of V1 and of V2.

6. The method according to claim 4, wherein the first preparation is an enzyme-containing preparation and the second preparation is an alkaline preparation.

7. The method according to claim 4, wherein after the dispensing of the first volume V1 and of the second volume V2, dispensing of a third volume V3 of a third preparation from the cartridge into the interior of the water-conveying household appliance occurs, the third preparation being different from the first and the second preparation.

8. The method according to claim 6, wherein the third preparation is a rinse aid preparation.

9. The method according to claim 1, wherein at least the release of a volume V2 of a second preparation from the cartridge into the interior of the water-conveying household appliance occurs, the release occurring substantially simultaneously with the first volume V1 of the first preparation, and the first and the second preparation being different from one another.

10. The method according to claim 1, wherein the dispensed volume V2 is equal to approximately 1*V1 to 10*V1.

11. The method according to claim 1, wherein at each conductivity measurement, a polarity reversal of the electrodes of the conductivity sensor occurs.

12. The method according to claim 1, wherein the water-conveying household appliance is an automatic dishwasher.

13. The method according to claim 1, wherein at least one measured value of the temperature sensor and/or conductivity sensor is transferred by means of an optical interface to an automatic dishwasher.

14. A dispensing system for carrying out the method according to claim 1, encompassing
a cartridge filled with at least one preparation,
a dispenser that is couplable to the cartridge, the dispenser encompassing at least
a temperature sensor and a conductivity sensor, such that the temperature sensor and/or the conductivity sensor can be arranged in and/or on and/or outside the dispenser, and
a delivery means for releasing a preparation from the cartridge into the interior of a water-conveying household appliance, and
a control unit that is coupled to the temperature sensor and to the conductivity sensor and to the delivery means, and in which the dispensing method according to one of the preceding claims is stored.
